(19) United States
(12) Patent Application Publication
(10) Pub. No.: US 2016/0218441 A1
(43) Pub. Date: Jul. 28, 2016

(54) APPARATUS AND METHODS FOR WIRELESS COMMUNICATION

(71) Applicant: NOKIA TECHNOLOGIES OY, Espoo (FI)

(72) Inventors: Ruiyuan Tian, Espoo (FI); Antti Karilainen, Helsinki (FI)

(21) Appl. No.: 14/915,900

(22) PCT Filed: Aug. 26, 2014
(86) PCT No.: PCT/FI2014/050647

§ 371 Date: Mar. 2, 2016

(30) Foreign Application Priority Data
Sep. 2, 2013 (GB) 1315554.4

(51) Int. Cl. H01Q 21/28; H01Q 1/52; H01Q 1/24

(52) U.S. Cl. CPC H01Q 21/28; H01Q 1/24; H01Q 1/521

(57) ABSTRACT

An apparatus for wireless communication comprising: a conductive member (22) comprising: a first radiator (24) configured to resonate in an operational frequency band; a second radiator (26) configured to resonate in an operational frequency band; a first non-conductive slot (28) between at least the first radiator (24) and the second radiator (26), the first non-conductive slot (28) being oriented in a first direction (parallel to the Y-axis 38); a third radiator (30) configured to resonate in an operational frequency band; and a second non-conductive slot (32) between at least the third radiator (30) and the first radiator (24), the second non-conductive slot (32) being oriented in a second direction (parallel to the X-axis 36), different to the first direction (38).

### TECHNOLOGICAL FIELD

Embodiments of the present invention relate to apparatus and methods for wireless communication. In particular, they relate to apparatus for wireless communication in electronic devices.

### BACKGROUND

Apparatus, such as portable electronic devices, usually include an antenna arrangement to enable the apparatus to communicate wirelessly. Such apparatus usually also include a cover to house the circuitry of the apparatus and the antenna arrangement. Recently, there has been a trend for covers of portable electronic devices to include a metal such as aluminium. Metal covers are advantageous in that they may provide a robust housing which is aesthetically attractive to users.

### BRIEF SUMMARY

According to various, but not necessarily all, embodiments of the invention there is provided an apparatus comprising: a conductive member comprising: a first radiator configured to resonate in an operational frequency band; a second radiator configured to resonate in an operational frequency band; a first non-conductive slot between at least the first radiator and the second radiator, the first non-conductive slot being oriented in a first direction; a third radiator configured to resonate in an operational frequency band; and a second non-conductive slot between at least the third radiator and the first radiator, the second non-conductive slot being oriented in a second direction, different to the first direction.

The apparatus may further comprise a cover portion configured to provide an exterior surface of an electronic device, the cover portion including the conductive member.

The apparatus may further comprise a cover portion configured to provide an exterior surface of an electronic device and to house the conductive member therein, the cover portion being separate to the conductive member.

The first radiator and the second radiator may form a multiple input multiple output (MIMO) antenna arrangement.

The first and second non-conductive slots may comprise dielectric material.

The first direction of the first non-conductive slot may be perpendicular to the second direction of the second non-conductive slot.

The third radiator may have a different physical length to the first and second radiators, the third radiator may be configured to resonate in a different operational frequency band to the first and second radiators.

The apparatus may further comprise a fourth radiator configured to resonate in an operational frequency band, the first non-conductive slot being positioned between the third radiator and the fourth radiator, the second non-conductive slot being positioned between the second radiator and the fourth radiator.

The apparatus may further comprise: a third non-conductive slot positioned adjacent the first non-conductive slot and being oriented in the first direction; and a conductive part positioned between the first non-conductive slot and the third non-conductive slot.

The conductive part may be configured to reduce electromagnetic interference between the first radiator and the second radiator.

The conductive part may be configured to operate as a radiator and resonate in an operational frequency band.

According to various, but not necessarily all, embodiments of the invention there is provided an electronic device comprising an apparatus as described in any of the preceding paragraphs.

According to various, but not necessarily all, embodiments of the invention there is provided a method comprising: providing a conductive member comprising: providing a first radiator configured to resonate in an operational frequency band; providing a second radiator configured to resonate in an operational frequency band; providing a first non-conductive slot between at least the first radiator and the second radiator, the first non-conductive slot being oriented in a first direction; providing a third radiator configured to resonate in an operational frequency band; and providing a second non-conductive slot between at least the third radiator and the first radiator, the second non-conductive slot being oriented in a second direction, different to the first direction.

The method may further comprise providing a cover portion configured to provide an exterior surface of an electronic device, the cover portion including the conductive member.

The method may further comprise providing a cover portion configured to provide an exterior surface of an electronic device and to house the conductive member therein, the cover portion being separate to the conductive member.

The first radiator and the second radiator may form a multiple input multiple output (MIMO) antenna arrangement.

The first and second non-conductive slots may comprise dielectric material.

The first direction of the first non-conductive slot may be perpendicular to the second direction of the second non-conductive slot.

The third radiator may have a different physical length to the first and second radiators, the third radiator may be configured to resonate in a different operational frequency band to the first and second radiators.

The method may further comprise providing a fourth radiator configured to resonate in an operational frequency band, the first non-conductive slot being positioned between the third radiator and the fourth radiator, the second non-conductive slot being positioned between the second radiator and the fourth radiator.

The method may further comprise: providing a third non-conductive slot positioned adjacent the first non-conductive slot and being oriented in the first direction; and providing a conductive part positioned between the first non-conductive slot and the third non-conductive slot.

The conductive part may be configured to reduce electromagnetic interference between the first radiator and the second radiator.

The conductive part may be configured to operate as a radiator and resonate in an operational frequency band.

### BRIEF DESCRIPTION

For a better understanding of various examples that are useful for understanding the brief description, reference will now be made by way of example only to the accompanying drawings in which:

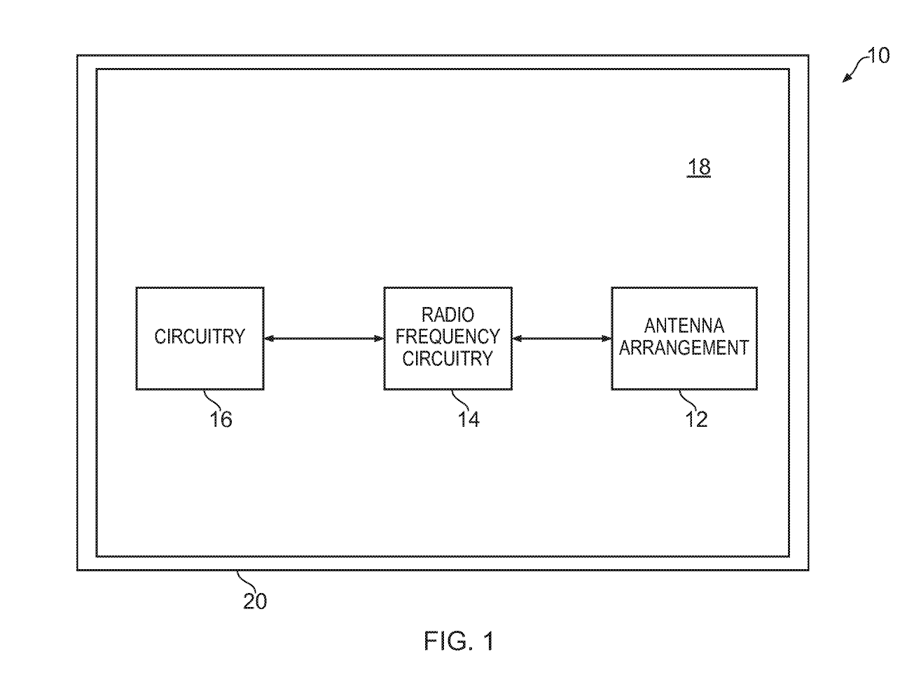

FIG. 1 illustrates a schematic diagram of an electronic device according to an example;

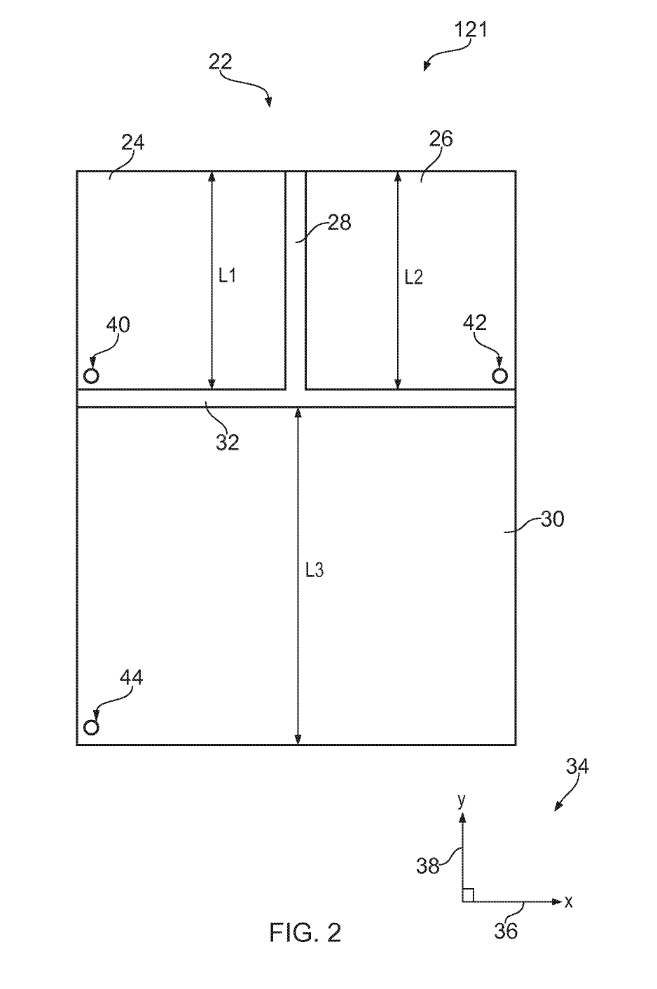

FIG. 2 illustrates a schematic plan view of an antenna arrangement according to an example;

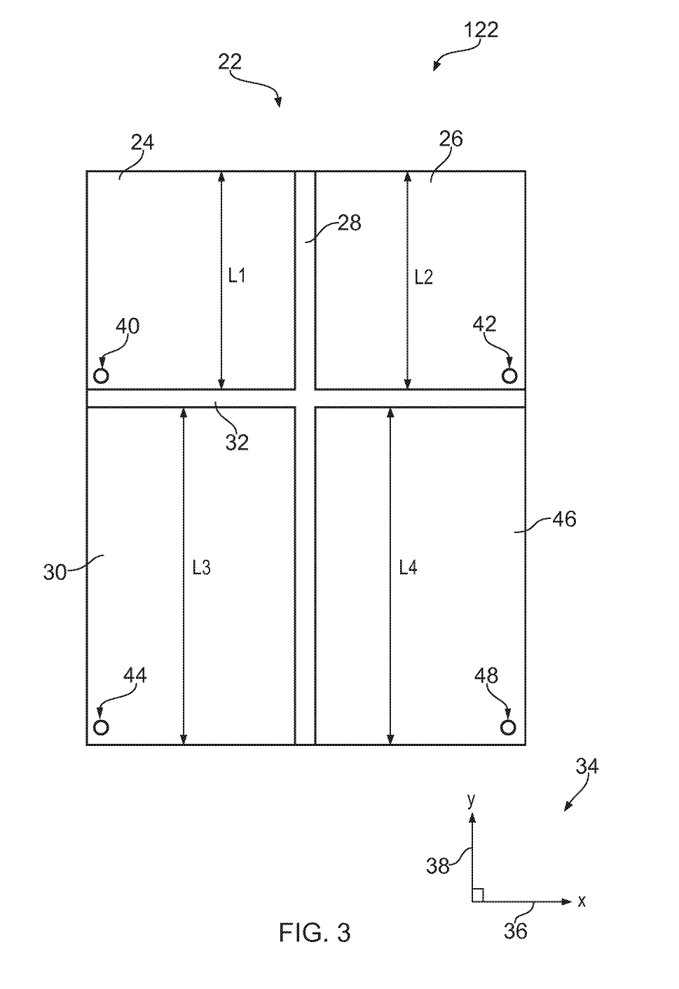

FIG. 3 illustrates a schematic plan view of another antenna arrangement according to an example;

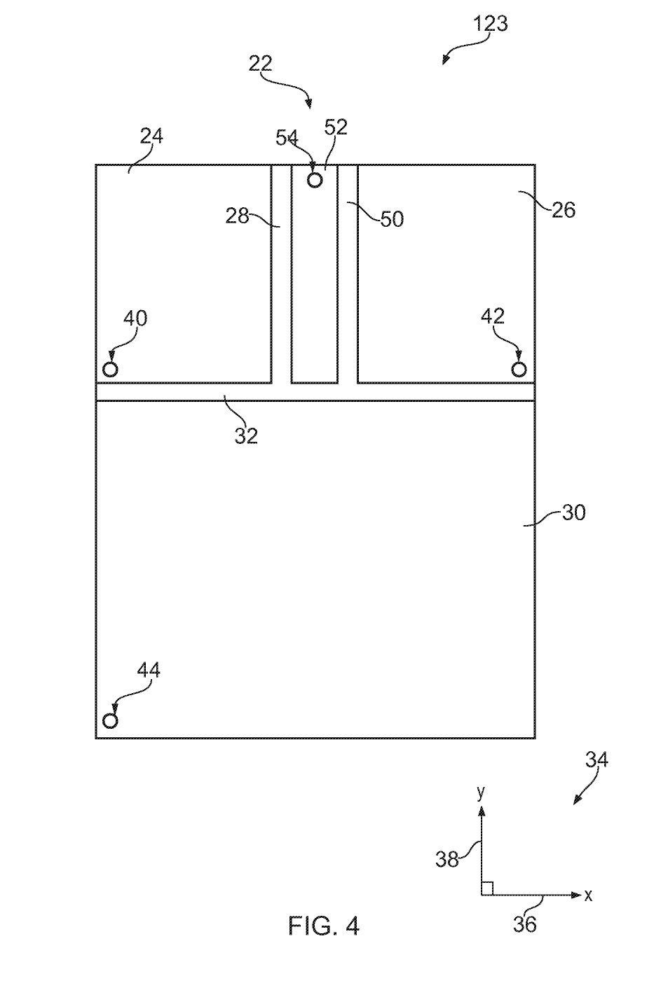

FIG. 4 illustrates a schematic plan view of a further antenna arrangement according to an example;

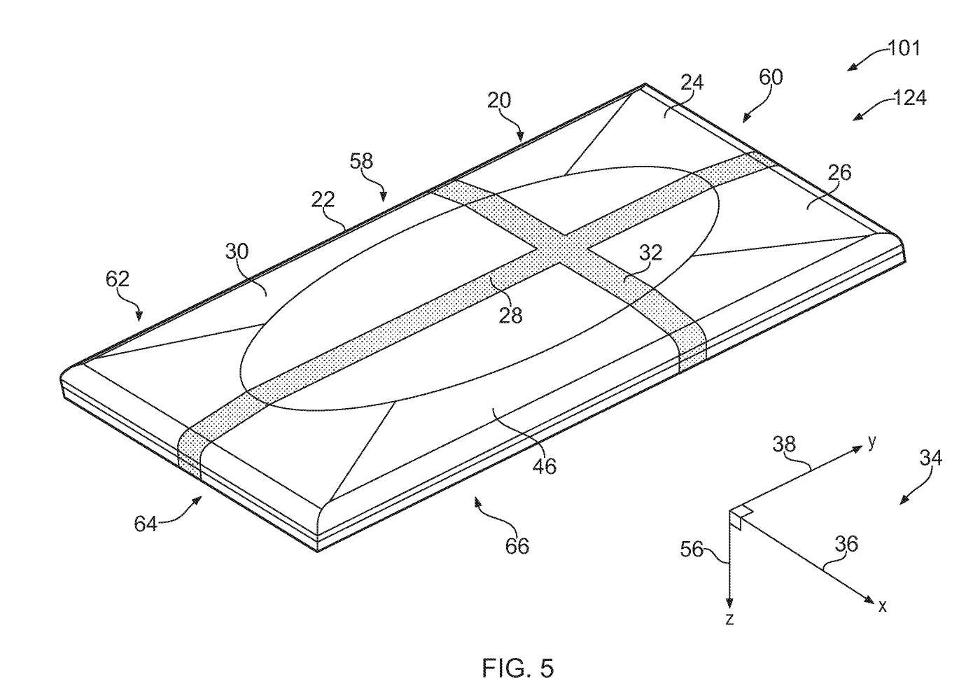

FIG. 5 illustrates a perspective view of the back of an electronic device according to an example;

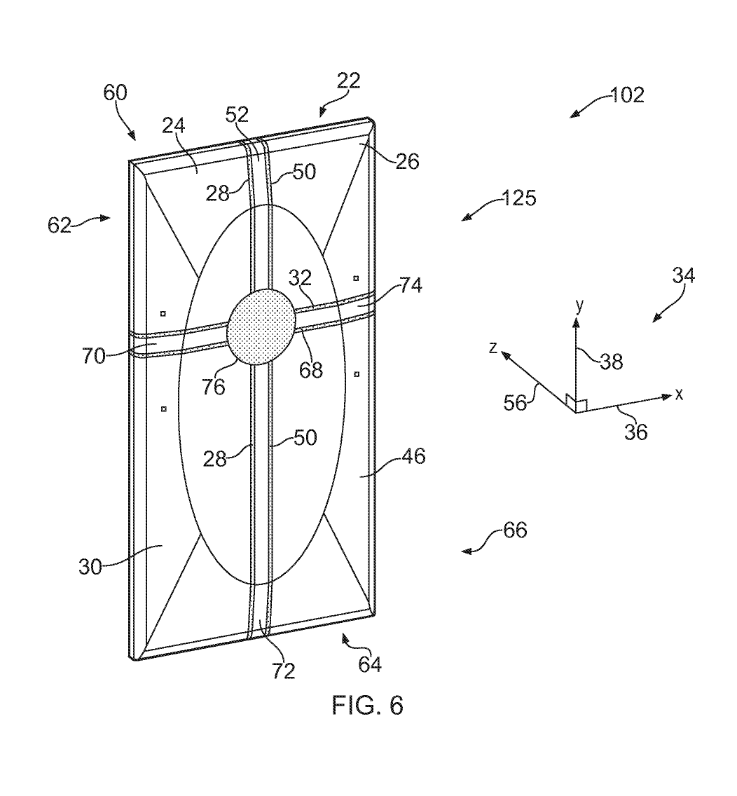

FIG. 6 illustrates a perspective view of the back of another electronic device according to an example;

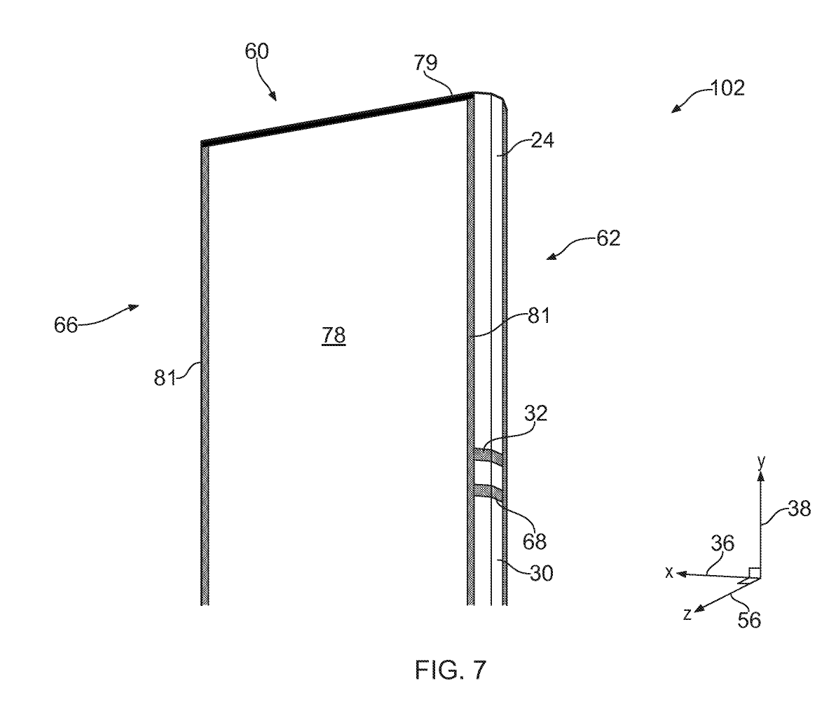

FIG. 7 illustrates a perspective view of the front of the electronic device illustrated in FIG. 6;

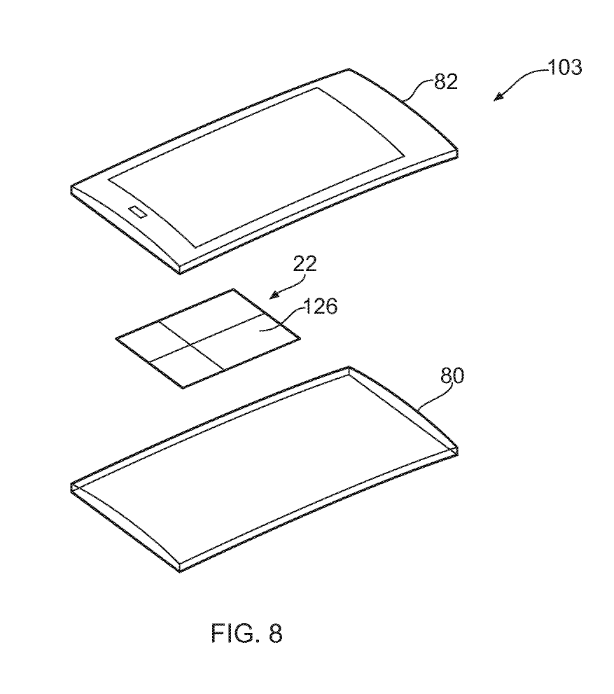

FIG. 8 illustrates an exploded perspective view of a further electronic device according to an example; and

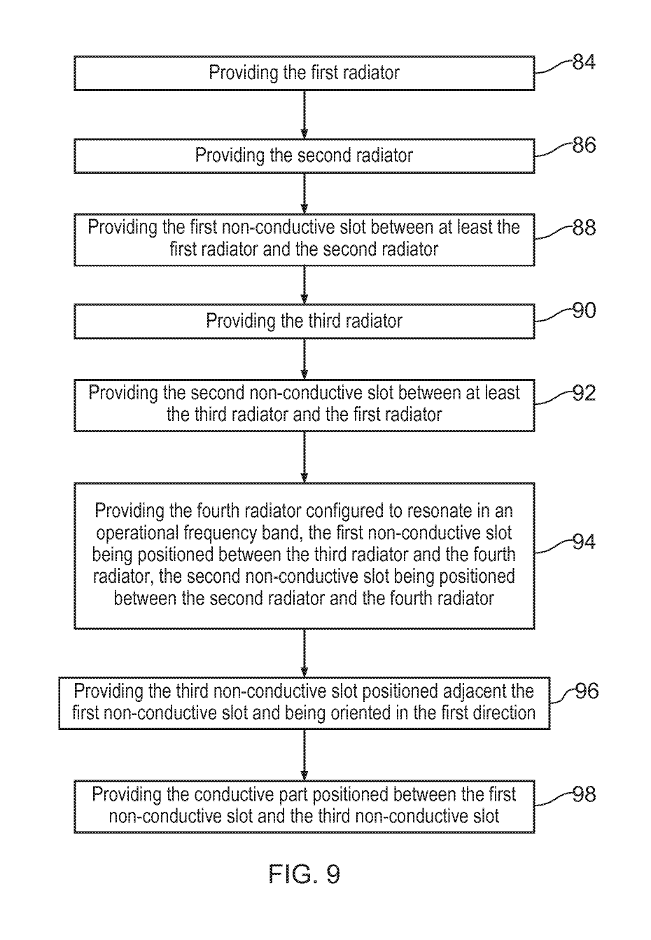

FIG. 9 illustrates a flow diagram of a method of manufacturing an electronic device according to an example.

### DETAILED DESCRIPTION

In the following description, the wording ‘connect’ and ‘couple’ and their derivatives mean operationally connected or coupled. It should be appreciated that any number or combination of intervening components can exist (including no intervening components). Additionally, it should be appreciated that the connection or coupling may be a physical galvanic connection and/or an electromagnetic connection.

In the following description, the term ‘radiator’ refers to an antenna that may be a ‘fed’ antenna (that is, where the antenna is directly coupled to radio frequency circuitry) or a ‘parasitic’ antenna (that is, where the antenna is coupled to radio frequency circuitry via another antenna).

FIGS. 2, 3, 4, 5, 6 and 8 illustrate an apparatus 10 comprising: a conductive member 22 comprising: a first radiator 24 configured to resonate in an operational frequency band; a second radiator 26 configured to resonate in an operational frequency band; a first non-conductive slot 28 between at least the first radiator 24 and the second radiator 26, the first non-conductive slot 28 being oriented in a first direction 38; a third radiator 30 configured to resonate in an operational frequency band; and a second non-conductive slot 32 between at least the third radiator 30 and the first radiator 28, the second non-conductive slot 32 being oriented in a second direction 36, different to the first direction 38.

FIG. 1 illustrates an electronic device 10 which may be any apparatus such as a hand portable electronic device (for example, a mobile cellular telephone, a tablet computer, a laptop computer, a personal digital assistant or a hand held computer), a non-portable electronic device (for example, a personal computer or a base station for a cellular network), a portable multimedia device (for example, a music player, a video player, a game console and so on) or a module for such devices. As used here, the term ‘module’ refers to a unit or apparatus that excludes certain parts or components that would be added by an end manufacturer or a user.

The electronic device 10 comprises an antenna arrangement 12, radio frequency circuitry 14, other circuitry 16, a ground member 18, and a cover 20. Where the electronic device 10 is a module, the electronic device 10 may only include the antenna arrangement 12 or may only include a combination of the antenna arrangement 12 and the cover 20.

The antenna arrangement 12 includes a plurality of radiators that are configured to transmit and receive, transmit only or receive only electromagnetic signals. The radio frequency circuitry 14 is connected between the antenna arrangement 12 and the other circuitry 16 and may include a receiver and/or a transmitter and/or a transceiver. The other circuitry 16 is operable to provide signals to, and/or receive signals from the radio frequency circuitry 14. The electronic device 10 may optionally include one or more matching circuits (which may comprise an impedance tuner), filters, switches, or other radio frequency circuit elements, and combinations thereof, between the antenna arrangement 12 and the radio frequency circuitry 14.

The radio frequency circuitry 14 and the antenna arrangement 12 may be configured to operate in a plurality of operational frequency bands. For example, the operational frequency bands may include (but are not limited to) Long Term Evolution (LTE) (B17 (DL:734-746 MHz; UL:704-716 MHz), B5 (DL:869-894 MHz; UL: 824-849 MHz), B20 (DL: 791-821 MHz; UL: 832-862 MHz), B8 (925-960 MHz; UL: 880-915 MHz) B13 (DL: 746-756 MHz; UL: 777-787 MHz), B28 (DL: 758-803 MHz; UL: 703-748 MHz), B7 (DL: 2620-2690 MHz; UL: 2500-2570 MHz), B38 (2570-2620 MHz), B40 (2300-2400 MHz) and B41 (2496-2690 MHz)), amplitude modulation (AM) radio (0.535-1.705 MHz); frequency modulation (FM) radio (76-108 MHz); Bluetooth (2400-2483.5 MHz); wireless local area network (WLAN) (2400-2483.5 MHz); hiper local area network (HiperLAN) (5150-5850 MHz); global positioning system (GPS) (1570.42-1580.42 MHz); US—Global system for mobile communications (US-GSM) 850 (824-894 MHz) and 1900 (1850-1990 MHz); European global system for mobile communications (EGSM) 900 (880-960 MHz) and 1800 (1710-1880 MHz); European wideband code division multiple access (EU-WCDMA) 900 (880-960 MHz); personal communications network (PCN/DCS) 1800 (1710-1880 MHz); US wideband code division multiple access (US-WCDMA) 1700 (transmit: 1710 to 1755 MHz, receive: 2110 to 2155 MHz) and 1900 (1850-1990 MHz); wideband code division multiple access (WCDMA) 2100 (transmit: 1920-1980 MHz, receive: 2110-2180 MHz); personal communications service (PCS) 1900 (1850-1990 MHz); time division synchronous code division multiple access (TD-SCDMA) (1900 MHz to 1920 MHz, 2010 MHz to 2025 MHz), ultra wideband (UWB) Lower (3100-4900 MHz); UWB Upper (6000-10600 MHz); digital video broadcasting—handheld (DVB-H) (470-702 MHz); DVB-H US (1670-1675 MHz); digital radio mondiale (DRM) (0.15-30 MHz); worldwide interoperability for microwave access (WiMax) (2300-2400 MHz, 2305-2360 MHz, 2496-2690 MHz, 3300-3400 MHz, 3400-3800 MHz, 5250-5875 MHz); digital audio broadcasting (DAB) (174.928-239.2 MHz, 1452.96-1490.62 MHz); radio frequency identification low frequency (RFID LF) (0.125-0.134 MHz); radio frequency identification high frequency (RFID HF) (13.56-13.56 MHz); radio frequency identification ultra high frequency (RFID UHF) (433 MHz, 865-956 MHz, 2450 MHz), inductive power standard (Qi) frequencies.

A frequency band over which an antenna can efficiently operate is a frequency range where the antenna's return loss is less than an operational threshold. For example, efficient operation may occur when the antenna's return loss is better than (that is, less than) −4 dB or −6 dB.

The other circuitry 16 may include processing circuitry, memory circuitry and input/output devices such as an audio input device (a microphone for example), an audio output device (a loudspeaker for example), a display, a camera, charging circuitry, and a user input device (such as a touch screen display and/or one or more buttons or keys).

The antenna arrangement 12 and the electronic components that provide the radio frequency circuitry 14 and the other circuitry 16 may be interconnected via the ground member 18 (for example, a printed wiring board). The ground member 18 may be used as a ground plane for the antenna arrangement 12 by using one or more layers of the printed wiring board. In other embodiments, some other conductive part of the electronic device 10 (a battery cover or a chassis (such as a display chassis) within the interior of the cover 20 for example) may be used as the ground member 18 for the antenna arrangement 12. In some examples, the ground member 18 may be formed from several conductive parts of the electronic device 10, one part which may include the printed wiring board. The ground member 18 may be planar or non-planar.

The cover 20 has an exterior surface that defines one or more exterior visible surfaces of the electronic device 10 and also has an interior surface that defines a cavity configured to house the electronic components of the electronic device 10 such as the radio frequency circuitry 14, the other circuitry 16 and the ground member 18. The cover 20 may comprise a plurality of separate cover portions that may be coupled to one another to form the cover 20. For example, the cover 20 may include a front cover portion that is provided by a display module, and a back cover portion that couples to the display module.

The structure of the antenna arrangement 12 is described in the following paragraphs with reference to the Figs.

FIG. 2 illustrates a schematic plan view of an antenna arrangement 121 according to an example. The antenna arrangement 121 includes a conductive member 22 comprising a first radiator 24, a second radiator 26, a first non-conductive slot 28, a third radiator 30 and a second non-conductive slot 32. The antenna arrangement 121 may be a part of the cover 20 (that is, the cover 20 comprises the antenna arrangement 121). In other examples, the antenna arrangement 121 may be physically separate to the cover 20 and may be housed within the cover 20.

FIG. 2 also illustrates a Cartesian co-ordinate axis 34 having an X axis 36 and a Y axis 38 that are orthogonal to one another.

The conductive member 22 has a rectangular shape and is planar and oriented parallel to the plane defined by the X axis 36 and the Y axis 38. In other examples, the conductive member 22 may have any other suitable shape (for example, square, circular, elliptical and so on) and may be non-planar and include one or more curved surfaces.

The conductive member 22 may be an integral structure where the components of the conductive member 22 (namely the first radiator 24, the second radiator 26, the first non-conductive slot 28, the third radiator 30 and the second non-conductive slot 32 in this example) are fixed together by one or more fasteners (such as an adhesive for example). In other examples, the conductive member 22 may not be an integral structure (that is, the components of the conductive member 22 are not directly fixed together), but may be fixed in position via connections to a support member (such as a printed wiring board).

The first radiator 24 (which may also be referred to as the first antenna 24) comprises a conductive material (for example, a metal such as aluminum or copper, or a conductive polymer) and is coupled to the radio frequency circuitry 14 via a first feed 40. The first radiator 24 may be directly electrically connected to the first feed 40 (that is, the first radiator 24 is galvanically connected to the first feed 40), or may be indirectly coupled to the first feed 40 (that is, by electromagnetic coupling between the first feed 40 and the first radiator 24). In some examples, the first radiator 24 may be a parasitic antenna and be coupled to the radio frequency circuitry 14 via another radiator. The first radiator 24 may or may not be grounded (for example, by being galvanically connected to a ground plane).

The first radiator 24 has a physical length L1 and a first electrical length (which includes the physical length L1 and any reactive components coupled to the first radiator 24). The first electrical length of the first radiator 24 is selected to enable the first radiator 24 to resonate in at least one operational frequency band.

The second radiator 26 (which may also be referred to as the second antenna 26) comprises a conductive material (for example, a metal such as aluminum or copper, or a conductive polymer) and is coupled to the radio frequency circuitry 14 via a second feed 42. The second radiator 26 may be directly electrically connected to the second feed 42 (that is, the second radiator 26 is galvanically connected to the second feed 42), or may be indirectly coupled to the second feed 42 (that is, by electromagnetic coupling between the second feed 42 and the second radiator 26). In some examples, the second radiator 26 may be a parasitic antenna and be coupled to the radio frequency circuitry 14 via another radiator. The second radiator 26 may or may not be grounded (for example, by being galvanically connected to a ground plane).

The second radiator 26 has a physical length L2 and a second electrical length (which includes the physical length L2 and any reactive components coupled to the second radiator 26). The second electrical length of the second radiator 26 is selected to enable the second radiator 26 to resonate in at least one operational frequency band.

The first non-conductive slot 28 is positioned between the first radiator 24 and the second radiator 26 and is oriented in a first direction (in this example, parallel to the Y axis 38). The first non-conductive slot 28 may abut the first and second radiators 24, 26 and in some examples, the first non-conductive slot 28 may be physically coupled to the first and second radiators 24, 26 (for example, by adhesive). The first non-conductive slot 28 may comprise a dielectric material or any other non-conductive material including air.

The third radiator 30 (which may also be referred to as the third antenna 30) comprises a conductive material (for example, a metal such as aluminum or copper, or a conductive polymer) and is coupled to the radio frequency circuitry 14 via a third feed 44. The third radiator 30 may be directly electrical connected to the third feed 44 (that is, the third radiator 30 is galvanically connected to the third feed 44), or may be indirectly coupled to the third feed 44 (that is, by electromagnetic coupling between the third feed 44 and the third radiator 30). In some examples, the third radiator 30 may be a parasitic antenna and be coupled to the radio frequency circuitry 14 via another radiator. The third radiator 30 may or may not be grounded (for example, by being galvanically connected to a ground plane).

The third radiator 30 has a physical length L3 and a third electrical length (which includes the physical length L3 and any reactive components coupled to the third radiator 30). The third electrical length of the third radiator 30 is selected to enable the third radiator 30 to resonate in at least one operational frequency band.

The second non-conductive slot 32 is positioned between the third radiator 30 and the first radiator 24 and between the third radiator 30 and the second radiator 26. The second non-conductive slot 32 is oriented in a second direction (parallel to the X axis 36 in this example) that is different to the first direction. It should be appreciated that the first non-conductive slot 28 and the second non-conductive slot 32 are oriented perpendicular to one another in this example. In other examples, the first non-conductive slot 28 and the second non-conductive slot 32 may be oriented at any (non-zero) oblique angle relative to one another.

The second non-conductive slot 32 may abut the first, second and third radiators 24, 26, 30 and in some examples, the second non-conductive slot 32 may be physically coupled to the first, second and third radiators 24, 26, 30 (for example, by adhesive). The second non-conductive slot 32 may comprise a dielectric material or any other non-conductive material including air.

The first electrical length of the first radiator 24 and the second electrical length of the second radiator 26 may be selected so that they are substantially the same. For example, the physical lengths L1 and L2 may be manufactured to provide desired first and second electrical lengths. By way of another example, reactive components coupled to the first and second radiators 24, 26 may be chosen to have impedances that provide the desired first and second electrical lengths. Consequently, the first and second radiators 24, 26 may be configured to resonate in the same operational frequency band and may be configured to form a multiple input multiple output (MIMO) antenna arrangement.

In some examples, the first radiator 24 and the second radiator 26 may be coupled to the radio circuitry 14 via a switch that enables the processing circuitry 16 to switch which of the first and second radiators 24, 26 is the main antenna and which is the diversity antenna of the multiple input multiple output (MIMO) antenna arrangement.

In other examples, the first electrical length of the first radiator 24 and the second electrical length of the second radiator 26 may be selected so that they are different and consequently, the first and second radiators 24, 26 may be configured to resonate in different operational frequency bands.

The third radiator 30 may have a different physical length (and therefore electrical length) to the first and second radiators 24, 26, and be configured to resonate in a different operational frequency band to the first and second radiators 24, 26. In this example, the physical length L3 of the third radiator 30 is greater than the physical lengths L1, L2 of the first and second radiators 24, 26 and has a longer electrical length than the first and second radiators 24, 26. Consequently, the third radiator 30 is configured to resonate in a lower operational frequency band than the first radiator 24 and the second radiator 26. In some examples, the third radiator 30 may be configured to resonate in higher harmonic frequencies which enable the third radiator to resonate in one or more additional (higher) operational frequency bands.

FIG. 3 illustrates a schematic plan view of another antenna arrangement 122 according to an example. The antenna arrangement 122 is similar to the antenna arrangement 121 illustrated in FIG. 2 and where the features are similar, the same reference numerals are used. The antenna arrangement 122 may be a part of the cover 20 (that is, the cover 20 comprises the antenna arrangement 122). In other examples, the antenna arrangement 122 may be physically separate to the cover 20 and may be housed within the cover 20. The conductive member 22 may or may not be an integral structure.

The antenna arrangement 122 differs from the antenna arrangement 121 in that the conductive member 22 further comprises a fourth radiator 46 (which may also be referred to as a fourth antenna 46). The fourth radiator 46 comprises a conductive material (for example, a metal such as aluminum or copper, or a conductive polymer) and is coupled to the radio frequency circuitry 14 via a fourth feed 48. The fourth radiator 46 may be directly electrical connected to the fourth feed 48 (that is, the fourth radiator 48 is galvanically connected to the fourth feed 48), or may be indirectly coupled to the fourth feed 48 (that is, by electromagnetic coupling between the fourth feed 48 and the fourth radiator 46). In some examples, the fourth radiator 46 may be a parasitic antenna and be coupled to the radio frequency circuitry 14 via another radiator.

The fourth radiator 46 has a physical length L4 and a fourth electrical length (which includes the physical length L4 and any reactive components coupled to the fourth radiator 46). The fourth electrical length of the fourth radiator 46 is selected to enable the fourth radiator 46 to resonate in at least one operational frequency band.

The first non-conductive slot 28 is positioned between the third radiator 30 and the fourth radiator 46 in addition to being positioned between the first radiator 24 and the second radiator 26. The second non-conductive slot 32 is positioned between the second radiator 26 and the fourth radiator 46 in addition to being positioned between the first radiator 24 and the third radiator 30.

One or more of the non-conductive slots 28, 32 may have the same physical width or different physical widths when the different slots 28, 32 are compared to each other. Additionally, along the length of a given non-conductive slot 28, 32, the width may vary and may have straight and/or curved shapes. This paragraph may apply to all examples of non-conductive slots.

The electrical length of the fourth radiator 46 may be selected so that the fourth radiator 46 is configured to resonate in the same operational frequency band as the third radiator 30. Consequently, the third and fourth radiators 30, 46 may be configured to form a multiple input multiple output (MIMO) antenna arrangement. In other examples, the electrical length of the fourth radiator 46 may be selected so that the third and fourth radiators 30, 46 are configured to resonate in different operational frequency bands.

FIG. 4 illustrates a schematic plan view of a further antenna arrangement 123 according to an example. The antenna arrangement 123 is similar to the antenna arrangement 121 and where the features are similar, the same reference numerals are used. The antenna arrangement 123 may be a part of the cover 20 (that is, the cover 20 comprises the antenna arrangement 123). In other examples, the antenna arrangement 123 may be physically separate to the cover 20 and may be housed within the cover 20. The conductive member 22 may or may not be an integral structure.

The antenna arrangement 123 differs from the antenna arrangement 121 in that the conductive member 22 further comprises a third non-conductive slot 50 that is positioned adjacent the first non-conductive slot 28 and is also oriented in the first direction (that is, parallel to the Y axis 38). The second radiator 26 is positioned adjacent (and may abut) the third non-conductive slot 50.

The conductive member 22 also includes a conductive part 52 positioned between the first non-conductive slot 28 and the third non-conductive slot 50. The conductive part 52 may comprise the same material as the radiators 24, 26, 30 and may consequently comprise a metal or a conductive polymer. The conductive part 52 may be grounded at a ground point 54 (for example, by a galvanic connection to a ground plane).

The conductive part 52 may be configured to reduce electromagnetic interference between the first radiator 24 and the second radiator 26. For example, the conductive part 52 may have an electrical length that is equal to a quarter wavelength of the operational frequency band of the first radiator 24 and/or the second radiator 26. In these examples, the conductive part 52 may function as a parasitic antenna for the first radiator 24 and/or the second radiator 26 and may widen the resonant frequency bandwidth of the first radiator 24 and/or the second radiator 26.

In other examples, the conductive part 52 may be configured to operate as a radiator and resonate in an operational frequency band. For example, the conductive part 52 may be connected to the radio frequency circuitry 14 via a feed point and be configured to provide a complementary wireless system antenna (Bluetooth for example) or provide a cellular antenna.

FIG. 5 illustrates a perspective view of the back of an electronic device 101 including an antenna arrangement 124. The antenna arrangement 124 is similar to the antenna arrangement 122 illustrated in FIG. 3, and where the features are similar, the same reference numerals are used.

FIG. 5 also illustrates the Cartesian coordinate axis 34 that includes the X axis 36, the Y axis 38 and a Z axis 56 which are orthogonal to one another.

The cover 20 of the electronic device 101 includes a first cover portion 58 that is configured to provide an exterior surface of the electronic device 101 (in this example, the exterior surface is the back surface and the side surfaces). The cover 20 also includes a second cover portion (not illustrated in FIG. 5) that is configured to provide the front surface of the electronic device 101. In some examples, the second cover portion is a display module.

The first cover portion 58 includes the conductive member 22 and hence the antenna arrangement 124. The conductive member 22 is an integral structure and thereby provides the first cover portion 58 with a robust structure. In some examples, the first cover portion 58 may only include the conductive member 22. In other examples, the first cover portion 58 may include one or more other members such as a plastic coating over the conductive member 22.

The conductive member 22 has a first edge 60, a second edge 62, a third edge 64 and a fourth edge 66. The first edge 60 includes the first radiator 24, the first conductive slot 28, and the second radiator 26. The second edge 62 includes the first radiator 24, the second conductive slot 32 and the third radiator 30. The third edge 64 includes the third radiator 30, the first non-conductive slot 28 and the fourth radiator 46. The fourth edge 66 includes the second radiator 26, the second non-conductive slot 32 and the fourth radiator 46.

The first and third edges 60, 64 are parallel to one another (and parallel to the X axis 36), and the second and fourth edges 62, 66 are parallel to one another (and parallel to the Y axis 38). The second and fourth edges 62, 66 are longer than the first and second edges 60, 64. At the edges 60, 62, 64 and 66, the conductive member 22 extends in the +Z direction.

The first and third edges 60, 64 are electrically grounded (which may be along the whole edge or only at one or more discrete point(s) along the edge). For example, the first and third edges 60, 64 are connected to a ground plane of the display module of the second cover portion. By way of another example, the first and third edges 60, 64 may be connected to any ground plane member/portion (for example, at least a part of a layer of a printed wiring board). The second and fourth edges 62, 66 are electrically open. For example, the second and fourth edges 62, 66 may be electrically insulated from the ground plane of the display module by an insulating member (for example, a non-conductive strip comprising plastic).

The electronic device 101 may provide several advantages. Firstly, since the radiators 24, 26, 30 and 46 may be relatively large, a user's hand may consequently be less likely to detune the radiators 24, 26, 30 and 46 when handling the electronic device. Secondly, due to the relatively large area of the radiators 24, 26, 30, 46, the distance from the radiators 24, 26, 30, 46 to electronic components (such as batteries and shielding) underneath the radiators may be relatively small while maintaining satisfactory radiation efficiency and frequency bandwidth.

FIG. 6 illustrates a perspective view of the back of another electronic device 102 including an antenna arrangement 125. The antenna arrangement 125 is similar to the antenna arrangement 124 illustrated in FIG. 5 and to the antenna arrangement 123 illustrated in FIG. 4, and where the features are similar, the same reference numerals are used.

FIG. 6 also illustrates the Cartesian coordinate axis 34 that includes the X axis 36, the Y axis 38 and the Z axis 56 which are orthogonal to one another.

The antenna arrangement 125 differs from the antenna arrangement 124 in that the conductive member 22 further includes a third non-conductive slot 50, a fourth non-conductive slot 68, a first conductive part 52, a second conductive part 70, a third conductive part 72, a fourth conductive part 74 and an aperture 76. The conductive member 22 has an integral structure.

The first and third non-conductive slots 28, 50 extend between the first and third edges 60, 64 of the conductive member 22 and are positioned adjacent one another. The first and third non-conductive slots 28, 50 are oriented parallel to the Y axis 38. The second and fourth non-conductive slots 32, 68 extend between the second and fourth edges 62, 66 of the conductive member 22 and are positioned adjacent one another. The second and fourth non-conductive slots 32, 68 are oriented parallel to the X axis 36.

The aperture 76 is defined in the conductive member 22 at a position halfway between the second and fourth edges 62, 66 and between the first and third edges 60, 64. In this example, the aperture 76 is positioned in closer proximity to the first edge 60 than to the third edge 64, however, it should be appreciated that in other examples the aperture 76 may be positioned anywhere on the first cover portion 58 of the electronic device 102. The aperture 76 within the conductive member 22 may receive a component of the electronic device 102 (such as a camera module) when the electronic device 102 is assembled.

The first conductive part 52 is positioned between the first non-conductive slot 28, the third non-conductive slot 50 and the aperture 76. The second conductive part 70 is positioned between the second non-conductive slot 32 and the fourth non-conductive slot 68 and the aperture 76. The third conductive part 72 is positioned between the first non-conductive slot 28, the third non-conductive slot 50 and the aperture 76. The fourth conductive part 74 is positioned between the second non-conductive slot 32, the fourth non-conductive slot 68 and the aperture 76.

The first, second, third and fourth conductive parts 52, 70, 72, 74 may comprise the same material as the radiators 24, 26, 30, 46 and may consequently comprise a metal or a conductive polymer. The first, second, third and fourth conductive parts 52, 70, 72, 74 may be grounded at a ground point (for example, by a galvanic connection to a ground plane). Alternatively, the first, second, third and fourth conductive parts 52, 70, 72, 74 may not be grounded at a ground point (for example, by having no galvanic connection to a ground plane). That is, the first, second, third and fourth conductive parts 52, 70, 72, 74 may be electrically floating to form, for example, half wavelength microwave structures.

The first, second, third and fourth conductive parts 52, 70, 72, 74 may be configured to reduce electromagnetic interference between the radiators 24, 26, 30 and 46. Alternatively, the first, second, third and fourth conductive parts 52, 70, 72, 74 may be configured to operate as radiators and resonate in one or more operational frequency bands. In some examples, at least one of the first, second, third and fourth conductive parts 52, 70, 72, 74 may be configured to reduce electromagnetic interference, and the remaining conductive parts may be configured to operate as radiators. Alternatively, at least one of the first, second, third and fourth conductive parts 52, 70, 72, 74 may be configured to operate as a radiator, and the remaining conductive parts may be configured to reduce electromagnetic interference between the radiators 24, 26, 30 and 46.

FIG. 7 illustrates a perspective view of the front of the electronic device 102 illustrated in FIG. 6.

The electronic device 102 includes a display module 78 that forms at least a part of the second (front) cover portion of the cover 20. The display module 78 includes a ground plane layer 79. The first and second radiators 24, 26 are grounded to the ground plane layer 79 of the display module 78 along the first edge 60. Similarly, the third radiator 30 and the fourth radiator 46 (not illustrated in this Fig.) are grounded to the ground plane layer 79 of the display module 78 along the third edge 64 (also not illustrated in this Fig.). The first and second radiators 24, 26 are insulated from the ground plane layer of the display module 78 along the second and fourth edges 62, 66 by an insulating member 81 (such as a plastic strip). Similarly, the third and fourth radiators 30, 46 are insulated from the ground plane layer of the display module 78 along the second and fourth edges 62, 66 by an insulating member 81.

In some examples, the first and second radiators 24, 26 are galvanically connected to the ground plane layer of the display module 78 along the second and fourth edges 62, 66 and insulating members (such as plastic strips) are provided along the second and fourth edges 62, 66 (that is, not at the interface of the first and second radiators 24, 26 and the ground plane layer, but within the side edges) to form an insulating gap between the first and second radiators 24, 26 and the ground plane layer of the display module 79. Similarly, the third and fourth radiators 30, 46 are galvanically connected to the ground plane layer of the display module 78 along the second and fourth edges 62, 66 and insulating members (such as plastic strips) are provided along the second and fourth edges 62, 66 (that is, not at the interface of the first and second radiators 24, 26 and the ground plane layer, but within the side edges) to form an insulating gap between the third and fourth radiators 30, 46 and the ground plane layer of the display module 79.

The electronic device 102 may be advantageous in that the conductive parts 52, 70, 72, 74 may be used to reduce electromagnetic interference between the radiators 24, 26, 30, 46 and/or be used to operate as antennas. This may result in the radiators 24, 26, 30 and 46 being relatively efficient. Furthermore, the conductive member 22 may provide a significant number (if not all) of the antennas of the electronic device 102 and may consequently enable the depth (the dimension in the Z axis 56) of the electronic device 102 to be reduced.

FIG. 8 illustrates an exploded perspective view of a further electronic device 103 according to an example. The electronic device 103 includes a conductive member 22 comprising an antenna arrangement 126, a first (rear) cover portion 80 and a second (front) cover portion 82.

The antenna arrangement 126 may have a structure as illustrated in any of FIG. 2, 3, 4, 5, 6 or 7, or may have a different structure. The conductive member 22 may or may not have an integral structure. The first cover portion 80 and the second cover portion 82 are configured to fasten together and house the conductive member 22 therein. The first cover portion 80 and the second cover portion 82 are physically separate to the conductive member 22 and therefore the conductive member 22 does not form part of the cover 20 of the electronic device 103. In some examples, the conductive member 22 may be smaller than illustrated in FIG. 8.

FIG. 9 illustrates a flow diagram of a method of manufacturing an electronic device according to an example. At block 84, the method includes providing the first radiator 84. At block 86, the method includes providing the second radiator 86. At block 88, the method includes providing the first non-conductive slot 28 between at least the first radiator 24 and the second radiator 26. At block 90, the method includes providing the third radiator 30. At block 92, the method includes providing the second non-conductive slot 32 between at least the third radiator 30 and the first radiator 24.

At block 94, the method may include providing the fourth radiator 46. The first non-conductive slot 28 is positioned between the third radiator 30 and the fourth radiator 46. The second non-conductive slot 32 is positioned between the second radiator 26 and the fourth radiator 46.

At block 96, the method may include providing the third non-conductive slot 50 adjacent the first non-conductive slot 28.

At block 98, the method may include providing the conductive part 52 between the first non-conductive slot 28 and the third non-conductive slot 50.

The blocks illustrated in the FIG. 9 may represent steps in a method and/or sections of code in a computer program. For example, a controller may execute the computer program to control machinery to perform the method of FIG. 9. The illustration of a particular order to the blocks does not necessarily imply that there is a required or preferred order for the blocks and the order and arrangement of the block may be varied. Furthermore, it may be possible for some blocks to be omitted.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one.”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

Although embodiments of the present invention have been described in the preceding paragraphs with reference to various examples, it should be appreciated that modifications to the examples given can be made without departing from the scope of the invention as claimed. For example, an antenna arrangement may have any number of radiators (greater than three) and may have any number of non-conductive slots (in addition to the first and second non-conductive slots 28, 32). Furthermore, an antenna arrangement may have any number of conductive parts positioned between non-conductive slots.

In some examples, the radiators may not be fed individually and instead, a feed may be coupled to two or more radiators. For example, the antenna arrangement 122 may be modified so that one feed is connected to the first and third radiators 24, 30 and/or one feed is connected to the second and fourth radiators 26, 46. In other words, one or two feeds can be placed on the second non-conductive slot 32, connecting the first and third radiators 24, 30, and/or the second and fourth radiators 26, 46 respectively. For example, when feeding the first and third radiators 24, 30, if a coaxial cable is used for implementation, the outer layer of the coaxial cable may be coupled to the first radiator 24, and the inner layer of the coaxial cable may be coupled to the third radiator 30. In this way, together with the printed wiring board (the first and third radiators 24, 30 are grounded to the printed wiring board at the top and bottom edges respectively), a folded dipole antenna may be formed. For the second and fourth radiators 26, 46 each radiator may be fed individually, or the second and fourth radiators 26, 46 may be used as parasitic antennas. Alternatively, the second and fourth radiators 26, 46 may be fed similarly to the first and third radiators 24, 30 so that a second folded dipole is formed and separated from the first one by the first non-conductive slot 28.

In some examples, one or more of the non-conductive slots may comprise one or more micro apertures that are formed, for example, by laser perforation of the conductive member 22. A non-conductive slot comprising one or more micro apertures may be advantageous in that they may not be visible to a user of the electronic device and consequently, the conductive member 22 may appear to the user to be a single piece of conductive material (such as metal). This may result in the electronic device having greater aesthetic appeal.

The one or more micro apertures have at least one dimension that is of the order of microns. In particular, a micro aperture may have at least one dimension that is of the order of single digit microns, tens of microns, or hundreds of microns.

The one or more micro apertures may be dimensioned to not be visible to a human eye. For example, where the width of a micro aperture is of single digit microns or low tens of microns (for example, 1 to 30 microns), the micro aperture may be invisible to the naked eye or may be barely visible to the naked eye.

The one or more micro apertures may be formed through any suitable process. For example, the one or more micro apertures may be formed through: laser perforation; patterning a conductive layer on a substrate; wet or dry chemical etching; plasma arc cutting; or micromachining (using grinding tools for example). Where the one or more micro apertures are formed through laser perforation, the micro apertures may be referred to as a laser perforated apertures.

A dielectric may at least partially fill the one or more micro apertures. The dielectric may comprise any suitable dielectric material and may be an anodization layer (comprising a metal oxide such as alumina, Al2O3, for example). The anodization layer may extend over other surfaces of the conductive member 22 so that the anodization layer appears to continuously cover the conductive member 22.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1-27. (canceled)

28. An apparatus comprising:
a cover portion configured to provide an exterior surface of an electronic device, the cover portion including the conductive member; and
the conductive member comprising:
a first radiator configured to resonate in a first operational frequency band;
a second radiator configured to resonate in a second operational frequency band;
a first non-conductive slot between at least the first radiator and the second radiator, the first non-conductive slot being oriented in a first direction;
a third radiator configured to resonate in a third operational frequency band; and
a second non-conductive slot between at least the third radiator and the first radiator, the second non-conductive slot being oriented in a second direction, different to the first direction.

29. An apparatus as claimed in claim 28, wherein the conductive member provides a back surface of the electronic device.

30. An apparatus as claimed in claim 28, wherein the cover portion is separable from the conductive member and configured to house the conductive member therein.

31. An apparatus as claimed in claim 28, wherein the first radiator and the second radiator form a multiple input multiple output (MIMO) antenna arrangement.

32. An apparatus as claimed in claim 28, wherein the first and second non-conductive slots comprise dielectric material.

33. An apparatus as claimed in claim 28, wherein the first direction of the first non-conductive slot is perpendicular to the second direction of the second non-conductive slot.

34. An apparatus as claimed in claim 28, wherein the third radiator has a different physical length to the first and second radiators, the third radiator being configured to resonate in a different operational frequency band to the first and second radiators.

35. An apparatus as claimed in claim 28, further comprising a fourth radiator configured to resonate in an operational frequency band, the first non-conductive slot being positioned between the third radiator and the fourth radiator, the second non-conductive slot being positioned between the second radiator and the fourth radiator.

36. An apparatus as claimed in claim 28, further comprising:
a third non-conductive slot positioned adjacent the first non-conductive slot and being oriented in the first direction; and
a conductive part positioned between the first non-conductive slot and the third non-conductive slot.

37. An apparatus as claimed in claim 36, wherein the conductive part is configured to reduce electromagnetic interference between the first radiator and the second radiator.

38. An apparatus as claimed in claim 36, wherein the conductive part is configured to operate as a radiator and resonate in an operational frequency band.

39. An apparatus as claimed in claim 28, wherein the conductive member is planar.

40. An apparatus as claimed in claim 28, wherein the first and second non-conductive slots comprise one or more micro aperture which are dimensioned such that they are not visible to the human eye.

41. An apparatus as claimed in claim 40, wherein the one or more micro aperture is at least partially filled with a dielectric material.

42. An apparatus as claimed in claim 28, wherein the cover member only includes the conductive member.

43. An electronic device comprising:
a cover portion configured to provide an exterior surface of an electronic device, the cover portion including the conductive member; and
the conductive member comprising:
a first radiator configured to resonate in a first operational frequency band;
a second radiator configured to resonate in a second operational frequency band;
a first non-conductive slot between at least the first radiator and the second radiator, the first non-conductive slot being oriented in a first direction;
a third radiator configured to resonate in a third operational frequency band; and
a second non-conductive slot between at least the third radiator and the first radiator, the second non-conductive slot being oriented in a second direction, different to the first direction.

44. A method comprising:
providing a cover portion configured to provide an exterior surface of an electronic device, the cover portion including the conductive member; and
providing a conductive member comprising:
providing a first radiator configured to resonate in a first operational frequency band;
providing a second radiator configured to resonate in a second operational frequency band;
providing a first non-conductive slot between at least the first radiator and the second radiator, the first non-conductive slot being oriented in a first direction;
providing a third radiator configured to resonate in a third operational frequency band; and
providing a second non-conductive slot between at least the third radiator and the first radiator, the second non-conductive slot being oriented in a second direction, different to the first direction.

45. A method as claimed in claim 44, wherein the conductive member is integrated in the cover portion.

46. A method as claimed in claim 44, wherein the cover portion is separate to the conductive member and configured to house the conductive member therein.

47. A method as claimed in claim 44, wherein the cover member only includes the conductive member.
